(19) United States
(12) Patent Application Publication
(10) Pub. No.: US 2014/0110316 A1
(43) Pub. Date: Apr. 24, 2014

(54) Flow Through Adsorber for TDS Ablation

(71) Applicants: Lih-Ren Shiue, Hsinchu (TW); Dzung-Shi Chang, Hsinchu (TW); Rui-Yao Li, Hsinchu (TW)

(72) Inventors: Lih-Ren Shiue, Hsinchu (TW); Dzung-Shi Chang, Hsinchu (TW); Rui-Yao Li, Hsinchu (TW)

(73) Assignee: ECO Watertech, Inc., Hsinchu (TW)

(21) Appl. No.: 13/657,297

(22) Filed: Oct. 22, 2012

(51) Int. Cl. C02F 1/42; B01D 41/02; B01D 35/00; B01D 15/04

(52) U.S. Cl. 210/85; 210/269; 210/258; 210/253

(57) ABSTRACT

Using seawater as a benchmark of water with high TDS (total dissolved solids) Raw seawater can be instantly and significantly desalted just by passing a flow through adsorber (FTA) without applying electricity to the adsorbent therein. Various precursors may be converted to dual-functional adsorbents for the FTA. A cation-adsorbing group and an anion-adsorbing group are grafted onto the surface of the adsorbents by phosphorylation and amination, respectively. Based on the applications, the adsorbent may be configured as membrane form or packed bed in the FTA. When the adsorbent becomes saturated, it can be regenerated online using liquids cleaner than the intake. Besides seawater, the FTA may be utilized for treating other TDS-infested wastewaters at very minimal cost.

### BACKGROUND OF THE INVENTION

1. Field of the Invention

This invention relates to a device, or flow through adsorber (FTA), for TDS ablation via adsorptive process that needs no power for the adsorption of ions. Using seawater as an example, its TDS is instantly reduced in large extent on contact with the adsorbent disposed in the FTA. Particularly, using adsorbent derived from agricultural wastes and biomass materials, the FTA can ablate the TDS of various liquids effectively and economically.

2. Background of the Related Art

TDS is a universal polluting issue in almost all wastewaters including sea water. To convert seawater into potable water, TDS therein is the major and the most difficult target to abate. Reverse osmosis (RO) and distillation are the two most widely used techniques for the TDS removal of seawater. Many solids become ions after being dissolved in water, and the ions can be facilely and instantaneously adsorbed by a static electrical field leading to desalination. Thereby, capacitive deionization (CDI) using the said field built in its treating unit, also known as the flow through capacitor (FTC), for seawater desalination is developed. For years, the current inventors have devoted to the CDI method, and attained several US patents, such as, U.S. Pat. Nos. 6,462,935 and 6,795,298. CDI can be a viable alternative to RO and distillation by offering the merits of chemical free, high water recovery-rate, low power consumption, as well as direct retrieval and storage of the operation energy. Nevertheless, CDI has a few disadvantages, including, high capital cost on using titanium (Ti) as the substrate of FTC electrodes, and expensive electronic controllers for the automatic regeneration of FTC electrodes, and worse yet, the adsorbent of FTC has low throughput and short lifetime.

A great number of works have developed various inexpensive adsorbents for reducing the TDS and COD (Chemical Oxygen Demand) of waters by an adsorptive process without electricity. For example, carbonized rice husk is employed to adsorb organic contaminants and colorants from wastewaters in U.S. Pat. Nos. 4,877,534 and 7,727, 398, respectively. In the U.S. Pat. Nos. 6,579,977 and 7,098,327, carbon-based adsorbents are prepared via the chemical reactions of agricultural wastes with reagents for removing heavy metal ions from water. Yabusaki in U.S. Pat. No. 7,803,937 claims a method of water softening using cabamidated cellulose. Also, Lori et al in J of Environmental Science and Technology, Vol 1(3), pp 124-134 (2008) disclose the preparation of activated carbon from agricultural straws for adsorbing dye. Shareef in World Journal of World Agricultural Science, Vol. 5(S), pp 819-831 (2009) reviews the removal of a wide range of heavy-metal contaminants from water using sorbents derived from the carbonization of a list of biomasses and industrial wastes. All of the aforementioned US patents and journal articles are incorporated herein as reference.

Because of the large surface area, high pore volume and miscellaneous surface functional groups, commercial activated carbon (AC) is widely utilized as a filtering material to abate many water-borne pollutants, but the said AC is not a TDS remover in the water-treatment industry. However, as shown in the above references, a broad spectrum of natural and synthetic products can be transformed into AC using low temperatures and benign chemicals, a process that is more economic than the commercial production of AC. Moreover, the charcoal derived from the wastes performs better than the commodity in many cases of water purification. Virtually all carbon-containing species can be made into charcoal adsorbents, including, sewage sludge, shells of grain and nut, lignocellulosic wastes, petroleum wastes, industrial wastes like tyres and rubbers, etc. Shen et al in Recent Patents on Chemical Engineering, Vol 1, PP 27-40, 2008 summarizes eight methods of surface modification for the wastes, as well as for porous AC. By converting the existing surface functional groups to the desired groups of atoms, while wastes may become specific adsorbents for removing specific contaminants from water, AC may be equipped with novel utility. The surface modification of AC particles designed for water treatment and other applications can be found in the US patent Numbers, for example, U.S. Pat. Nos. 3,658,790; 4,851,120; 6,107,401; 6,117,328; 6,900,157 and 8,052,783, just to name a few.

Among the surface-modifying methods, the present invention finds two are very useful, namely, phosphorylation and amination. While the first reaction can form a cation-adsorbing group, the second reaction provides a group for anion adsorption. By performing anionization and cationization in sequence on a precursor, a dual functional adsorbent is thereby created as taught in U.S. Pat. No. 7,098,327 ('327). Nevertheless, '327 and other works on water-treatment using adsorptive process have not addressed an adsorbent or a device containing a sorbent for massive desalination of seawater, brine or waters that have the TDS-reduction issues. Moreover, the prior arts are lack of the implementation of viable online regeneration of adsorbent for continuous operation. In the present invention, a FTA filled with a dual-functional activated carbon in membrane or packed bed form, or a bed of rice-husk charcoal is proposed for seawater desalination and water softening in large volume under continuous flow mode without applying electricity to the FTA adsorbent. When the adsorbent is saturated, it can be instantly and repeatedly regenerated online using tap water, deionized water, surface water and seawater with TDS lower than the intake.

### SUMMARY OF THE INVENTION

One objective of the invention is to prepare a dual-functional activated carbon (AC) for seawater desalination using the minimal amount of chemicals, the lowest reaction temperatures and as short processing time as possible. For the simultaneous removal of both cations and anions from seawater, the AC particles should be equipped with dual-functional groups. Thus, the chosen AC powder or AC granule is subjected to 2 chemical treatments, phosphorylation and amination, in the said sequence. In non-biotic phosphorylation, phosphoric acid (H₃PO₄) is the main reagent, and it may be aided with dibasic ammonium phosphate [(NH₄)₂HPO₄] and urea. In general, the phosphorylation of AC is conducted from 140° C. to 200° C. for 1 to 3 hours under air atmosphere. On the other hand, the amination of AC has more selection of reagents, including, ammonia, aliphatic and aromatic amines, heterocyclic compounds, ammonium bases and salts. Amination is typically conducted under 45° C. to 100° C. for 6 to 12 hours. Due to the lower treatment temperatures of amination, it is applied after phosphorylation on the chosen AC subject. After phosphorylation, the AC particles are thoroughly stripped off the chemicals employed prior to applying the amination. Following the amination, the dually treated AC particles are once again washed and cleaned. Finally, the AC particles are dried thermally with vacuum for a period of time before storage.

Powdery or granular AC is a commodity widely utilized in water treatment. However, the material is generally expensive. Various agricultural wastes are present around the world, which may be viable alternatives to AC for purifying water. The present invention evaluates a number of crop wastes in Taiwan and rice husk is chosen as the candidate of adsorbent for replacing AC, the second objective of the present invention. Without pretreatment, the dry husk is first carbonized by the same phosphorylation chemicals employed for AC, but the reaction temperature is raised to 200-500° C. In the air atmosphere, phosphoric acid and the said temperature convert the brown husk into charcoal in a short period of time, which is then thoroughly washed off acidic residues. Using the same protocol of amination for AC, the rice-husk charcoal is turned into a dual-functional adsorbent.

While the best implementation of dual-functional AC granule and rice husk charcoal is packed bed, the dual-functional AC powder should be configured differently to avoid excessive pressure drop in the FTA made thereby. Thus, the third objective of the present invention is the deployment of dual-functional AC powders in the FTA. Three fixation methods of the AC powder on a substrate, such as, plastic grid, mesh, net, screen or web, is assessed. Firstly, a paste of the AC powder with binders and solvents is prepared for fixing the powder onto a plastic mesh through spray coating and thermal curing. Secondly, a desired dose of dual-functional AC powder is dispersed homogenously in the matrix of a polymer to form a porous membrane. Thirdly, the AC of a non-woven mat is imparted dual functionality by phosphorylation and amination. Compared with the coated FTA mesh, the FTA membranes derived from the dispersion of AC powder in a polymer matrix have the advantages of higher ion removal rate per unit weight of adsorbent, as well as better adhesion and easier operation.

Arrangement of AC mesh and AC membranes in the housing of FTA is the fourth objective of the invention. By folding the FTA mesh or FTA membrane in an accordion configuration for inserting into a plastic tube, a self-sustained cartridge of flow through adsorber (FTA) is thereby constructed. As the throughput of FTA cartridge is dependent upon the total surface area of FTA provided per tube, the most efficient way of building a large surface area in a small volume is to wind a rectangular sheet of FTA mesh or FTA membrane around a center tube concentrically into a spiral module. In the FTA cartridge, the intake water is flown perpendicularly to the surface of the FTA mesh or FTA membrane for the maximal adsorption of ions from water. The feed water enters the FTA unit by the intake tube, and it is distributed evenly through the FTA module to the outlet. On its way out of the adsorbent layers of spiral module, the intake water will lose its ionic contents to the dual-functional AC on contact. To regenerate a saturated FTA from adsorbing the ions in seawater, a housing-full tap water is flown through the unit and the adsorbed ions will be instantly desorbed resulting in a revived FTA. Sorption-desorption cycle of the FTA packed bed, FTA mesh and FTA mat is a facile and reversible process.

### BRIEF DESCRIPTION OF THE DRAWINGS

The present invention is best understood by reference to the embodiments described in the subsequent sections of draft in accompany with the following drawings.

FIG. 1 is a flow chart of fabrication process for preparing a dual functional activated carbon wherein the carbon powder is subjected to phosphorylation first for grafting a cation-adsorbing group to the surface of activated carbon, followed by amination for planting an anion-adsorbing group on the surface of carbon powders.

FIG. 2 is a schematic diagram of making a FTA membrane by securing a dual functional activated carbon on a polymer mesh. Next, the membrane is folded in an accordion form for being disposed into a plastic tubular housing to constitute a FTA unit of TDS-reduction. The arrows indicate that the feed water is flown perpendicularly to the surface of FTA membrane.

FIG. 3 is a spiral module of FTA element formed by concentrically winding a rectangular sheet of adsorbent net or mat around a perforated center tube that allows water to flow into the FTA unit.

FIG. 4 is a diagram for the proof of principle, wherein the TDS reduction of seawater is plotted against the cycle numbers of sorption-desorption, showing the feasibility of seawater desalination by a FTA membrane made by spray coating.

FIG. 5 is another diagram for the proof of principle, wherein the TDS reduction of seawater is plotted against the sorption-desorption cycle numbers of FTA treatment. In FIG. 5, the FTA membrane is made by dispersing the same dual-functional activated carbon as FIG. 4 in a polymer matrix. FIG. 5 shows the feasibility of desalinating seawater to freshwater by the FTA membrane.

FIG. 6 is a diagram of FTA composed of an adsorbent in packed bed.

FIG. 7 is a diagram of four units of packed-bed FTA connected in series.

### DETAILED DESCRIPTION OF THE INVENTION

The invention presents an adsorptive technique for seawater desalination using economic adsorbents for effectively removing ions from raw seawater at very minimal power consumption. For almost two decades, the inventors of the present invention have devoted to the development of capacitive deionization (CDI) technology as a chemical free and energy effective method for seawater desalination, and the efforts are seen in the U.S. Pat. Nos. 6,462,935; 6,795,298, and patents elsewhere. CDI depends upon a static electric field built in its treatment unit known as flow through capacitor (FTC) for adsorbing ions from seawater that passes through the charged FTC. CDI is operated by applying only 1-3 volts DC to the FTC electrodes based on activated carbon (AC), and at least ⅓ of the electricity input for ion removal can be directly retrieved and stored for reuse at the regeneration of FTC electrodes, which makes CDI more energy effective than distillation and reverse osmosis (RO). However, the intrinsic ion-adsorption by micro pores on the surface of AC, also, the inevitable water electrolysis at 1-3V DC, CDI may never become a viable method for commercial seawater-desalination. The foregoing side reactions will lead to incomplete electrode regeneration and electricity leak, respectively. Because of the said interference, CDI is not suitable for desalinating seawater or other salty liquids with TDS higher than 5,000 ppm. Had CDI been utilized for treating liquids with TDS higher than the said level, the FTC electrodes will be instantly saturated beyond regeneration resulting in poor CDI performance. Pragmatically, the CDI technique demands a TDS-leveling device to alleviate the technique from low capability and hard regeneration. FTA of the present invention may fulfill the needs of CDI.

A great number of water purification is accomplished via adsorptive action between water-borne contaminants and specific functional groups on various adsorbents. By design, these functional groups may be built on the surface of celluloses, polymer resins, crops, clays, ceramics, biomasses, metal oxides and activated carbons. Ionic contaminants that can be removed by adsorption include single or solvated ions, heavy metals, organics, minerals, blood and proteins. Generally speaking, separation of ionic contaminants from water by an adsorptive process consumes no power, and requires no expensive setup. Also, if the binding force between ions and an adsorbent is physical attraction, the adsorbed ions can be quickly driven off the adsorbent surface leading to instant regeneration of adsorbent. In Table 1, a few adsorbent-adsorbate pairs are listed to show the connection between ionic contaminants and the specific functional groups that remove them via adsorptive process. Table 1 focuses on the ion-adsorbing groups, thus, the substrates that carry the functional groups are not included in Table 1 for the sake of clarity.

TABLE 1
Adsorbent-Adsorbate Pairs

| Adsorbing Functional Groups | Ions Adsorbed |
|---|---|
| amino/imino/thiol | heavy metal ions |
| carboxyl/phosphoric | Mg²⁺/Ca²⁺ |
| nitrile | Cu²⁺/Pb²⁺ |
| pyridine/thiazole | Ag⁺, Hg²⁺, Pd²⁺, Au³⁺ |
| sulfonic | monovalent metal ions (Na⁺/K⁺) |
| ammonium | PO₄³⁻, NO₃⁻, CrO₄²⁻ |
| FeOH | SO₄²⁻, AsO₃³⁻, C₂O₄²⁻ |
| MgAl—CO₃-layered double | Cl⁻ |
| hydroxide | |
| NO₂, NH₂ | Benzoate, carboxyl, dye anions |

### Dual-Functional Adsorbents

None of the functional groups listed in Table 1, or other similar groups ever published in the literature, is intended for seawater desalination in large scale. The missed development of “adsorptive desalination” may be due to seawater is a complex wastewater containing 35 g salt dissolved in 1 liter water, or TDS is 35,000 ppm averagely, and refractory organic contaminants are present as well. In a typical seawater, the 5 most abundant cations in a decreasing order are Na⁺, Mg²⁺, Ca²⁺, K⁺ & Sr²⁺, similarly, the five most abundant anions include Cl⁻, SO₄²⁻, HCO₃⁻, BC and H₂BO₃⁻. For simultaneous removal of cation/anion from seawater using adsorptive process, the adsorbent employed should have a large surface area covered with adsorbing sites formed by dual-functionality groups. A group of materials, including, activated carbon, carbon nano tubes, metal oxides (for example, magnesium oxide, alumina, manganese oxide, zinc oxide), metal carbides (for example, magnesium carbide and barium carbide), cellulose, cottons, wools, polymer fibers, clays, ceramics, silica, and biomass may be utilized as the sorbents for performing adsorptive desalination. In the present invention, AC is first selected to demonstrate the merits of AC-based FTA for seawater desalination though novel surface modification coupling with the following unique properties of AC:

1. Abundant precursor sources;
2. Large surface area;
3. Inert to seawater and contaminants therein;
4. Easy to process;

### 5. Eco-friendly and

6. Low cost (relative to nano-tubes and inorganic adsorbents).

From Table 1, phosphate (PO₄³⁻) group is selected for the adsorption of cations, and NH₄⁺/NH₂ is picked for adsorbing anions, respectively, in the conduction of adsorptive desalination. A commodity AC is adopted as base for carrying the said groups. Two surface reactions, namely, phosphorylation and amination are performed in sequence to graft the dual-functional groups onto the chosen AC powder. The AC powder procured is a derivative of coconut shell with a specific surface area of 1,000 m²/g, and it is usually applied as a filtering material for potable water and for VOC (volatile organic compound) by the utility companies and by the semiconductor industry. However, without the chemical treatments as claimed in the present invention, the chosen AC, or other more exotic AC powders for this matter, has no power to abate the TDS of seawater whatsoever.

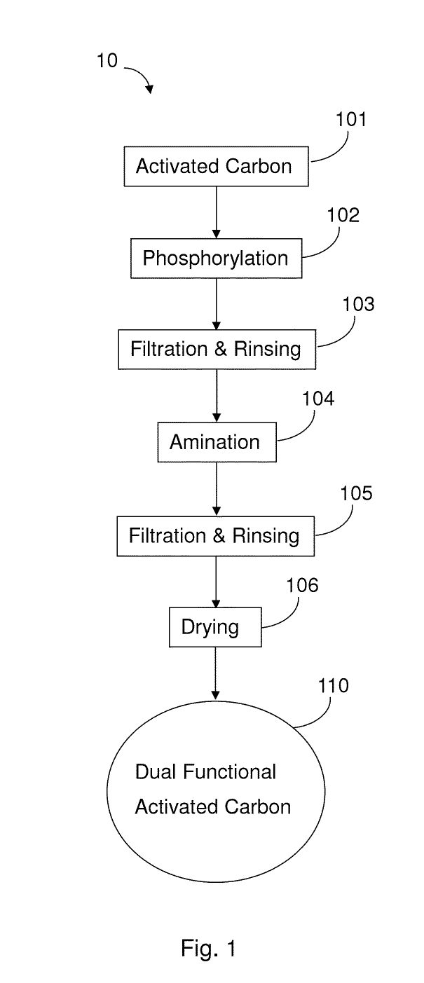

FIG. 1 shows a preferred embodiment of functionalizing transformation of the chosen AC powder into a dual functional adsorbent in the present invention. In the flow process 10 of FIG. 1, the chosen AC powder of desired quantity is loaded at step 101 into a reaction vessel, which may be a ceramic, glass or stainless steel pot. Then, the reagents required for phosphorylation based on the weight of AC are formulated and poured to the reaction vessel. For the phosphorylation of AC powder, phosphoric acid (H3PO4) is the primary reagents, which may be aided by dibasic ammonium phosphate [(NH4)2HPO4] and urea [CO(NH2)2] under a temperature range of 140-200° C. for 1-3 hours. After phosphorylation, the treated AC slurry is filtered and washed off reagent residues using tap water and de-ionized water at step 103. It is important to purify the wet carbon powders as clean as possible to eliminate any possible interference to the following treatment, that is, amination. Both pH and TDS of filtrate are monitored to control the cleaning process. For amination, there are many reagents available for the amination of AC, for instance, ammonia (NH3), tertiary and quaternary amines, heterocyclic nitrogen compounds, ammonium hydroxides, and ammonium salts, including, chlorides, bromides, nitrates and sulfates. The present invention has selected a reagent from the aforesaid chemicals for the amination of the acid-treated AC powder at step 104, which is conducted under 45-100° C. for 6-12 hours. After amination, the slurry of AC powder is filtered and washed/rinsed once more at step 105 to get rid of the amination residues. Following the phosphorylation and amination, the doubly treated AC powder is dried under heat and vacuum for hours at step 106. Finally, the dry and dual-functional AC powder is collected and stored at step 110. Since the phosphorylation is carried out at a temperature significantly higher than that of amination, the former reaction is carried out first to avoid thermal damage to the functional groups imparted by the amination. However, the drying temperature applied to the dual-functional AC powder appears causing no harm to the amino or ammonium groups imparted by the amination.

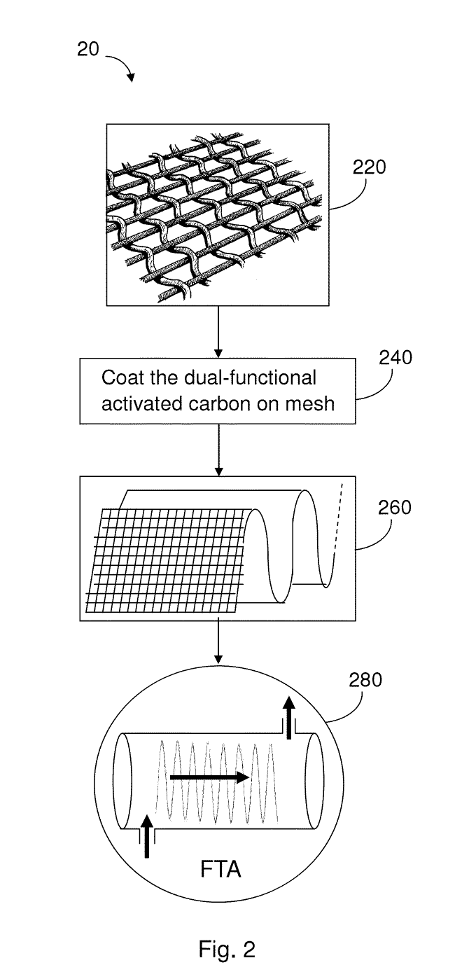

When used as a filtering medium, AC is generally packed in a fixed bed. Due to the fine sizes, AC powders tend to form slurry with water resulting in percolation of water rather than free flow in FTA. Hence, the present invention immobilizes the dual-functional AC powder on a porous support so that water has free access to the adsorbent during the short duration in FTA. On the basis of inertness and cost, the support used for the dual-functional AC powder is a polymeric substance. A number of polymers may serve as the support base for the AC powders, for instance, cellulose acetate, cellulose triacetate, polyamide, polypropylene, polysulfone, polycarbonate, polyvinyl chloride, polyester, and ploytetrafluoro ethylene. Furthermore, the polymer support is in a form of mesh, net, network, screen, or web for water to flow through the coated mesh freely and quickly. FIG. 2 shows a preferred embodiment of fabricating the coated mesh and the assembly of the coated mesh in a housing to form a FTA unit for TDS-ablation. In the flow process 20 of FIG. 2, a polymer mesh in the desired dimensions is attained at step 220. A paste of the dual-functional AC powder is coated via spray coating on the mesh and cured at step 240. Next, the coated mesh is folded as an accordion at step 260. By inserting as many straps of the adsorbent mesh as needed into a plastic tubing, a self-sustained FTA unit is thereby constructed at step 280. As shown in FIG. 2, the water flow in the FTA is perpendicular to the coated mesh for the optimal use of adsorbent. It is the binder that secures the dual-functional AC powders on the polymer mesh, the lifetime of adsorbent mesh is decided by the adhesion provided by the binder. Nevertheless, when the coated mesh is bent, or when water flow exerts a pressure on the coating continuously, AC loss due to detachment of coating is inevitable.

In order to minimize the loss of AC-coating, also to eliminate the masking of the AC surface by binder, the present invention evaluates 2 embodiments on fusing the dual-functional AC powder with a polymer support into a monolith. In one approach, a desired dosage of AC powder is dispersed homogenously in a melt polymer matrix followed by non-woven calendaring into a porous sheet of adsorbent membrane. In another deployment, a pre-made mat of un-treated AC powder is modified using the protocol of FIG. 1 into an adsorbent mat. The treatments of FIG. 1 are indiscriminative to the types of AC powder making the carbon mat. Using phosphorylation and amination, the AC powder contained in the carbon mats are imparted the dual functionality that is powerful on abating TDS of seawater. Both of adsorbent membrane and adsorbent mat may adopt the same FTA assembly as described in FIG. 2 to produce the self-sustainable FTA unit for TDS reduction. By appearance, the above adsorbent membrane and adsorbent mat look like the sponges filled with abrasive minerals utilized for scrubbing scales off utensils. Besides the dosage of AC powder making the adsorbent membrane and adsorbent mat can be adjusted, the dimensions of flow-channels in the 3D matrix of membrane can also be custom made to meet the application needs. Similar AC powder-filled devices can be found in the carbon cloth for N-95 respirator face masks, air filters and bamboo charcoal fabrics, as well as in the U.S. Pat. No. 6,117,328 issued to Sikdar et al, by the title of “Adsorbent-Filled Membranes for Pervaporation”.

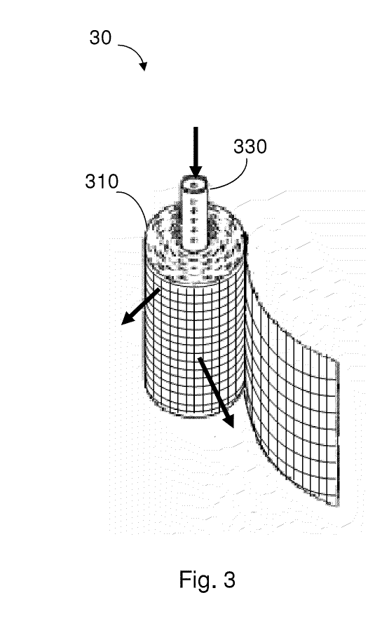

Adsorptive desalination by FTA depends upon the total area of adsorbent mesh, adsorbent membrane or adsorbent mat provided per FTA unit. Similar logic is held in the filtering elements of the filtration cartridges of ultra-filtration and RO. Universally, all filtering elements are made in spirally wound form. The reason is that the spiral roll can yield a large membrane area in a small volume. FIG. 3 shows a preferred embodiment of a spiral element for FTA wherein a rectangle sheet of adsorbent mesh, adsorbent membrane, or adsorbent mat is wound into a spiral configuration. In the spiral module 30 of FIG. 3, a sheet of mesh, membrane or mat 310 is wounded concentrically around a center intake tube 330 into a cylindrical roll. Further, the scroll surface of the roll is sealed to prevent water leakage. As shown in FIG. 3, a number of through holes are made on the center tube 330 for the intake water to enter the roll and to flow at right angle to the adsorbent layer in the direction as the arrows indicated in FIG. 3. As the intake water flows through the roll, the water-borne ions will be retained by the adsorbent on contact. When the adsorbent is saturated, adsorbed ions can be expelled to renew the adsorbent surface simply by flowing a proper amount of rinsing water through the FTA cartridge. The adsorbent roll for FTA as that show in FIG. 3 may adopt the same production protocol of filtering elements of μ-filtration and RO, hence, the existing cartridges of the latter may be assumed for making the FTA cartridges as well. Using the popular, long-existing parts of filtration for the FTA units, people do not have to change their habits on using the novel water-treatment devices. Thus, the promotion of desalting, or TDS ablation, of water by FTA may be facilitated.

Manufacturing of activated carbon (AC) is a highly polluting process, it is not only energy intensive on applying 400° C. for carbonization and 800° C. for activation, it also yields a tremendous amount of carbon dioxide and smoke. However, some of the precursors used for producing AC can be transformed into various dual-functional adsorbents using a carbonizing process at lower temperatures and shorter duration than the fabrication of AC. Although the low-temperature carbonization forms a charcoal rather than AC, the charcoal is a more potent adsorbent for adsorptive desalination than AC. For the reaction of char-making is conducted in the presence of wet chemicals, no smoldering or combustion is involved to generate in CO2 or smoke. There are plentiful of agricultural wastes and biomass materials available around the world, which can be converted to TDS-ablating adsorbents. A short list of the precursors is provided as follows:

1) Husk of grain: rice, wheat, barley, oat, rye, maize, soybean and sorghum.

2) Shell/seed of fruit: coconut, palm, durian, mongo, and peach stone.

3) Pericarp of fruit: pineapple, orange, pomelo, jackfruit and bagasse.

4) Shell of nut: peanut, pecan, cashew, almond, walnut and acorn.

5) Fiber and lignin: flax, wood chips, saw dust, bamboo and cellulose.

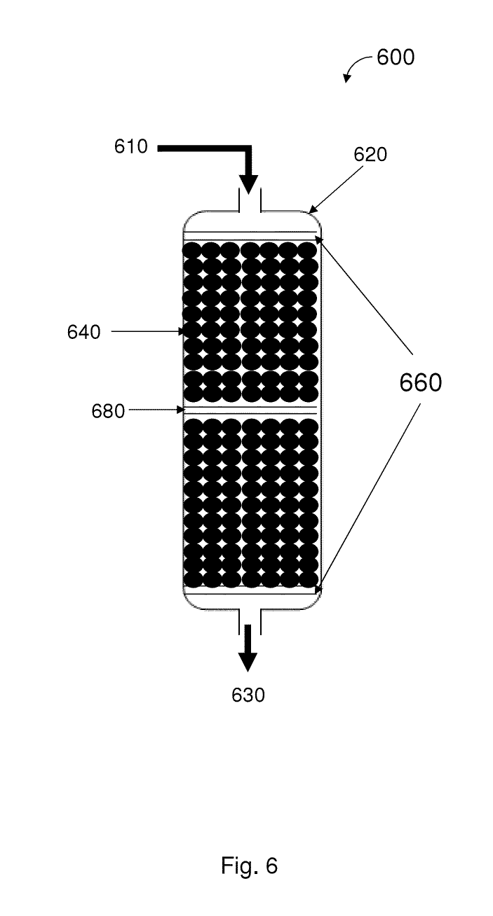

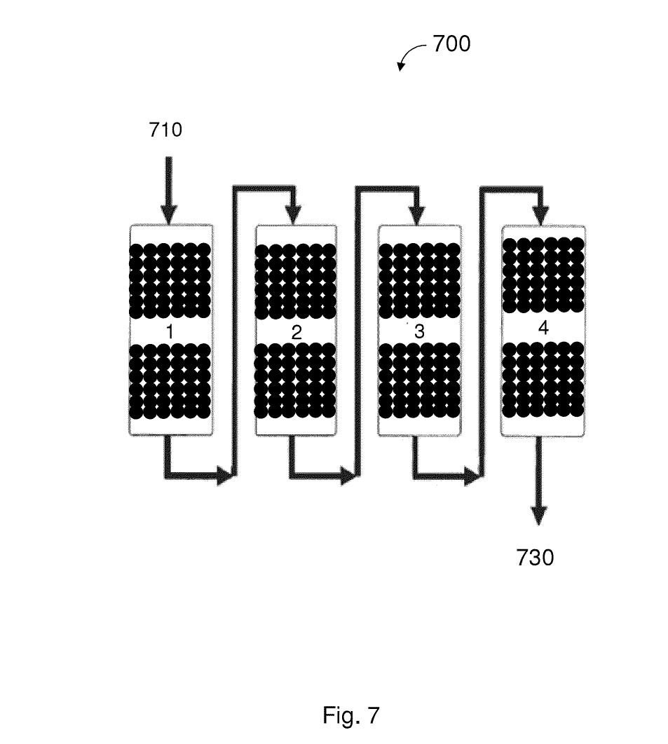

Rice husk is chosen by the present invention for assessing the feasibility of converting the annual waste to an adsorbent to ablate the TDS of seawater, waste water and tap water. Without any pre-treatment, a rice husk available in Taiwan is treated as received by the phosphorylation and amination processes as depicted in FIG. 1. The firmness of rice husk is derived from 2 hard materials including silica (SiO2) and lignin [C9H10O3.(OCH3)0.9-1.7]n. In typical composition of rice husk, cellulose [(C6H10O5)x] is the major ingredient ranging from 44% to 60%, which include lignin and hemicellulose [(C5H8O4)m]. The rest components of rice husk are mineral ash of SiO2 and volatile materials, including water, fat, and protein. Lignin is a mononuclear aromatic polymer that cements cellulose fibers, and it combines with hemicellulose to direct water flow in plants. In the present invention, phosphorylation mainly carbonizes lignin, but, it also imparts ion-adsorbing groups on the char fibers. For the first goal, the treatment is run at 200-400° C. Carbonization extent of rice husk, indicated by black coloration, depends on the weight ration between rice husk and chemicals, as well as on the pyrolysis temperature and time. The more the rice husk is carbonized, the higher the ion-adsorption rate will be. However, over charring the rice husk can lose a large mass to particulates. On the other hand, the amination conditions for rice-husk char remain the same as that for activate carbon (AC). Different from AC, the rice-husk char is best utilized in the form of packed bed for TDS ablation. FIG. 6 shows the preferred embodiment of disposing the rice-husk char in a FTA unit. In the FTA cartridge 600, the particles of rice-husk char is packed firmly with two supporting grid 660 to form a fixed bed in a housing 640. Depending on the aspect ratio, or, width of housing to the length of adsorbent, one liquid-dispersion grid 680, or more, may be interposed in the packed bed to distribute water flow evenly through the adsorbent bed. Waste water flows into FTA 600 at entrance 610, and the deionized water exits the FTA from port 630 by gravity feed or pump delivery. For attaining a high throughput per one treatment, a plural of FTA units can be connected in series, as the pack 700 depicted in FIG. 7 where four FTA units filled with dual-functional rice-husk char are linked in series. Waste water flows from entrance 710 to exit 730 for cascading ablation of TDS. Using the chemical treatments presented by the invention, other precursors from the aforementioned list of agricultural wastes and biomass materials may be transformed into the TDS-ablation adsorbents as the rice husk.

Regardless of adsorbent mesh, adsorbent membrane, adsorbent mat or packed bed of adsorbent, FTA employing the said adsorbent can reduce the TDS of water significantly and instantly via the contact between adsorbent and water. Moreover, the chemical treatments of the present invention can convert AC in powder/pellet form, agricultural wastes or biomass stocks to the potent adsorbents. Ion removal by the adsorbents is not achieved by ion exchange for the adsorbents are regenerated using water with TDS level lower than that of the treated waste water. In some cases, there is no or very few ion present in the rinsing water, such as, distilled water or water purified by an RO system. Hence, the adsorptive desalination of the present invention is likely a physical attraction between the adsorbing sites and adsorbates, which is govern by the ionic strength of water. It appears that the water of low ionic strength can flush out the ions adsorbed from the water of high ionic strength. Followings are four examples for demonstrating the capability and capacity of FTA using different adsorbents developed in the present invention, but the examples do not serve as limitations on the application scopes of the invention.

### Example 1

Without adjustment, a raw seawater taken from Taiwan Strait is treated by FTA mesh consisted of dual-functional activated carbon (AC). The mesh is AC on a polypropylene (PP) web in the dimensions of 100 mm width×1,000 mm length×0.6 mm thickness with openings of 1 mm² diameter. The dosage of AC is 60 g/1 m². Six (6) straps of the said FTA mesh, which has an overall AC weight of 36 g, folded into accordion for inserting into a plastic container. Then, 5-liter of the said seawater is poured into the container, and the water is allowed to flow directly through the pack of FTA web into a collecting vessel for TDS measurements. Immediately after desalination, 2-liter of tap water is flown directly through the pack of FTA web to regenerate the six FTA straps. One ion adsorption and one desorption, or adsorbent regeneration, constitutes a cycle of seawater desalination. Averagely, one cycle desalination requires 1 minute of operation time, and the FTA straps are ready for the next run of desalination.

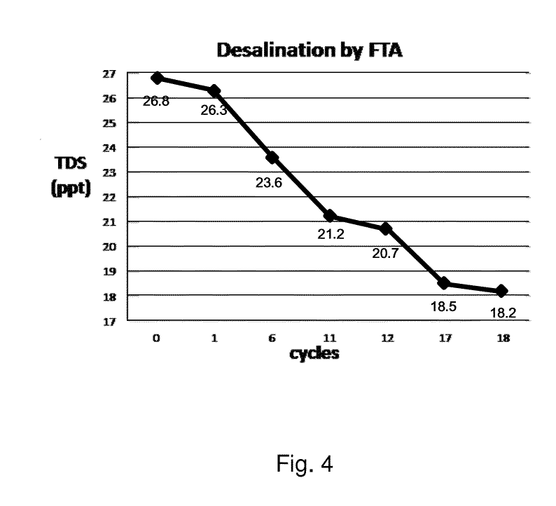

FIG. 4 shows the TDS ablation of seawater versus the number of treat cycles. The beginning TDS of seawater is 26.8 ppt (parts per thousand), and the water is treated in five consecutive cycles before a TDS measurement is taken. Three comments may be drawn from the data of FIG. 4 as follows:
1. A single cycle of desalination may reduce the TDS of 5 L seawater by 300-500 ppm (parts per million), yet, every five consecutive cycles can reduce the TDS by 2200-2600 ppm.
2. Rinsing the FTA straps with tap water can fully regenerate the surface of adsorbents.
3. As the salt content of seawater becomes low, the total ion-removal per desalination cycle decreases accordingly.

In Example 1, the FTA is regenerated before the adsorbent is saturated. Saturation of FTA can be detected by monitoring the TDS of effluent. When the effluent TDS shows an increasing trend, the adsorbent has reached saturation. Hence, the right time for regenerating the FTA can be determined by an online conductivity/TDS monitor. The adsorption capacity of the dual-functional AC may be expressed as milliequivalents per gram (mEq/g), or, the weight ratio between the salt adsorbed, such as, NaCl, and the weight of AC adsorbent. Unlike the ion exchange resins containing a fix number of single functional groups per unit weight, the AC adsorbent can carry dual-functional groups, and the adsorbent may be arranged in various forms including mesh, membrane, mat or packed bed. In the latter case, both AC and its host matrix of polymer will be imparted two kinds of functional groups.

### Example 2

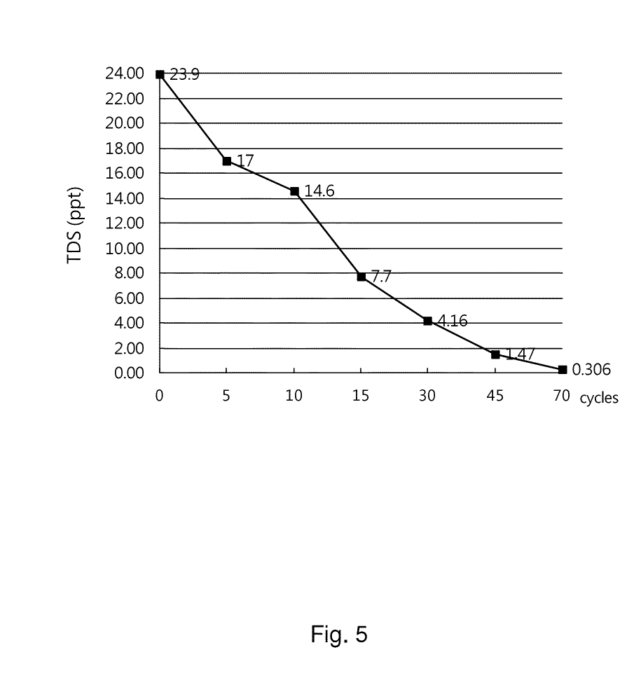

The same dual-functional AC powder used for making the mesh from of Example 1 is dispersed as a filler in a stretched polypropylene (PP) matrix to form a adsorbent membrane at 240 g AC/m2 of membrane. A section of the membrane in dimensions of 150 mm width×470 mm length×3 mm thickness, which is equivalent to 17 g AC adsorbent, is taken to desalinate 1 liter of raw seawater using the same accordion configuration for adsorbent mesh, and operation of desalination-regeneration cycles as Example 1. FIG. 5 shows the reduction of seawater TDS versus the number of desalination cycles. It indicates that the 1 L seawater is desalted from 23,900 ppm down to 306 ppm, a TDS level qualified as freshwater. Besides the adsorbent membrane, there is no other treatment employed for the seawater desalination of Example 2.

Comparing to FIG. 4, the adsorbent membrane of FIG. 5 can remove about 4 times of salt per desalination cycle based on the same weight of AC adsorbent. The major difference between the adsorbent membrane and adsorbent mesh is that the former has a 3D structure, a clear benefit to the efficiency of ion removal. In FIG. 5, a decreasing trend of TDS reduction rate as the salt content of seawater becomes low is also observed. Nevertheless, the desalination rate per cycle remains at 25% averagely. It means, regardless of the salt content, 25% salt of an intake seawater may be removed in the adsorptive desalination by the adsorbent membrane. Because there is higher AC content in adsorbent mat than that of adsorbent membrane, the former has a higher desalination rate than the latter.

### Example 3

Except using an AC dosage of 60 g powder/m2, a similar membrane as Example 2 is employed in a seawater desalination plant located by the sea in Northeastern China. A sum of the adsorbent membranes at dimensions of 150 mm width×300,000 mm length×3 mm thickness is disposed in a tandem of 6 FTA units, wherein each unit is 6″ diameter by 40″ length filled with 7.5 m2 adsorbent membrane in accordion configuration. A raw seawater with TDS of 24,000 ppm is desalted only by the tandem FTA setup. Table 2 is a typical treatment data showing the TDS of the first effluent and the subsequent TDS values of effluent recorded per minute.

TABLE 2
Field Test of Desalination by FTA Membrane
TDS of Influent: 24,800 ppm
Water flow rate: 0.6 m³/hour

| Timeline of Effluents (min) | TDS of Effluents (ppm, mg/L) |
|---|---|
| 0 | 240 |
| 1 | 410 |
| 2 | 550 |
| 3 | 990 |
| 4 | 1,500 |
| 5 | 2,400 |
| 6 | 4,320 |
| 7 | 8,700 |
| 8 | 10,450 |
| 9 | End of elution, FTA regeneration |

At flow rate of 0.6 m3/hour, 10 liters of effluent can be collected in 1 minute. Although Table 1 shows the feasibility of adsorptive desalination, the use of FTA in adsorbent membrane for commercial desalination of seawater requires the completion of the following works, for example, frequency of adsorption and regeneration switching, an automatic control of FTA regeneration, strategy of regeneration including use of rinsing water, post-treatment of rinsing water, as well as recycle of seawater minerals. Nonetheless, the present invention has proved the feasibility of using dual-functional AC-based FTA for seawater desalination without power applied to the adsorbent. The robustness and fast regeneration of the FTA unit are demonstrated as well.

### Example 4

A rice-husk adsorbent is prepared through carbonization by two chemical treatments at low temperatures, phosphorylation and amination, as described in FIG. 1. 480 g of the dry RH adsorbent is packed in 6 tubes at 80 g per tube to from 6 FTA cartridges of fixed bed, which are then linked in series for water to flow through the FTA pack for a sequential deionization similar to the setup of FIG. 7. An empty FTA cartridge has a capacity of 500 cc, and the RH-char bed therein can hold 250-350 cc of water. Four aqueous solutions are treated in one flow through the 6-pack of FTA cartridges, and typical results of ΔTDS at ion adsorption and FTA regeneration are summarized in Table 3:

TABLE 3
Four Aqueous Solutions Deionized by Rice-Husk Char-based FTA

| | Aqueous Solution or | | | TDS (ppm) | | ΔTDS |
|---|---|---|---|---|---|---|
| Test | Rinsing Water | | Volume | Initial | Final | (ppm) |
| 1 | 2 L of Tap | Effluent | 0.5 L | 120 | 38.8 | −90.2 |
| | Water | Retained | 1.45 L | 120 | 63.7 | −65.3 |
| | Deionized water by RO | | 800 cc | 1 | 84.8 | +83.8 |
| 2 | 2 L of | Effluent | 0.5 L | 1,740 | 72.5 | −1,667 |
| | reactor | Retained | 1.45 L | 1,740 | 1,190 | −550 |
| | cooling | | | | | |
| | water | | | | | |
| | Tap Water | | 800 cc | 131 | 1,350 | +1,219 |
| 3 | 3 L of | Effluent | 1.3 L | 19,300 | 8,070 | −11,230 |
| | plating | Retained | 1.65 L | 19,300 | 17,800 | −1,500 |
| | water | | | | | |
| | Tap Water | | 1 L | 131 | 17,950 | +17,819 |
| 4 | 3 L of raw | Effluent | 1.15 L | 32,200 | 15,500 | −16,700 |
| | seawater | Retained | 1.65 L | 32,200 | 26,000 | −6,200 |
| | Tap Water | | 1 L | 132 | 21,750 | +21,618 |

As seen in Table 3, a drastic difference of ΔTDS exists between the water that exits the FTA pack, and the water that is retained by the beds of adsorbent. The former shows a much larger TDS reduction or −ΔTDS than that of the latter. Table 3 also indicates a fast decreasing −ΔTDS as more water leaving the FTA. Decrease in −ΔTDS signifies that the adsorbent is reaching its adsorption limits resulting in low ablation of TDS. Hence, the maximal volume of waste water in one-flow treatment of TDS ablation via FTA is dependent upon the total weight of adsorbent and the adsorption capability/capacity of adsorbent. Without the activation process, which is normally conducted under 800-900° C. and O2-free condition, the surface area of rice husk charcoal (RH char) is smaller than that of activated carbon (AC), nevertheless, RH char has a better adsorption property than AC, and RH char is superior to AC in regeneration. AC has more ii-pores than RH char, apparently, the pores are detrimental to adsorptive desalination. One advantage of dual-functional AC adsorbent is that the material loss during process is significantly lower than that of RH char. Carbonization of rice husk may lose 20-30% material from the original due to the loss of volatile materials, tar, ashes and particulates. From the perspectives of lignin and ash contents, bagasse and bamboo are better precursors than rice husk for making the char adsorbents for the former has higher lignin and less ash.

### CONCLUSION

More than four decades, adsorptive process for seawater desalination has been developed towards the use of capacitive deionization (CDI) via a flow through capacitor (FTC) as the desalting tool. Activated carbon and carbon aerogel are the two starting materials employed for the fabrication of FTC electrodes. Currently, nanotubes of carbonaceous materials and metal oxides are added to the list. Besides high cost, all carbonaceous materials suffer the difficulty of complete recovery of the surface of adsorbent. As ions adsorbed in the μ-pores of the carbon-based materials, they are difficult to expel resulting in a great loss of FTC electrodes. The activated carbon used in the present invention does not have the power to ablate TDS of water, yet, by means of phosphorylation and amination, the said carbon becomes a potent adsorbent for power-free desalination of seawater. The present invention has also demonstrated the conversion of an agricultural waste, that is, rice husk, to a more potent adsorbent than dual-functional AC to perform more advanced adsorptive desalination. There are numerous agricultural wastes and biomass materials with the potential of becoming economical adsorbents for eradicating the toughest contaminant, namely, TDS, in liquids. The FTA offered by the present invention not only can serve as a TDS-leveling device for CDI, but also it can replace the chemical pretreatments aimed to reduce TDS in many water treatment techniques and systems.

What is claimed is:

1. A flow through adsorber (FTA) for TDS ablation comprising:
at least a FTA unit, comprising;
a housing; and
a dual-functional adsorbent disposed in the housing with at least one configuration, the dual-functional adsorbent comprising a cation-adsorbing group and a anion-adsorbing group on the surface of the dual-functional adsorbent;
at least an inlet on the housing for liquid to enter the FTA unit;
at least an outlet on the housing for the liquid to exit from the FTA unit;
at least a pump to drive the liquid through the FTA unit for TDS ablation;
at least a rinsing liquid to regenerate the FTA unit;
a first electronic controller to control the TDS ablation; and
a second electronic controller to control the said regeneration of the FTA unit.

2. The flow through absorber (FTA) for TDS ablation as claimed in claim 1, wherein the dual-functional adsorbent is prepared from a precursor selected from a group of materials containing activated carbon, carbon nano tubes, magnesium oxide, alumina, silica, manganese oxide, zinc oxide, magnesium carbide, and barium carbide.

3. The flow through absorber (FTA) for TDS ablation as claimed in claim 1, wherein the dual-functional adsorbent is prepared from a precursor selected from the husk, seed, pericarp or fiber of a group of materials containing rice, wheat, barley, oat, rye, maize, soybean, sorghum, coconut, palm, durian, mongo, peach stone, pineapple, orange, pomelo, jackfruit, bagasse, peanut, pecan, cashew, almond, walnut, acorn, flax, wood chips, saw dust, bamboo and cellulose.

4. The flow through absorber (FTA) for TDS ablation as claimed in claim 1, wherein the cation-adsorbing group is imparted by phosphorylation.

5. The flow through absorber (FTA) for TDS ablation as claimed in claim 4, wherein phosphoric acid (H₃PO₄) is the primary reagent of phosphorylation.

6. The flow through absorber (FTA) for TDS ablation as claimed in claim 1, wherein the anion-adsorbing group is imparted by amination.

7. The flow through absorber (FTA) for TDS ablation as claimed in claim 6, wherein the reagent of amination can be selected from a group of chemicals containing ammonia (NH₃), tertiary and quaternary amines, heterocyclic nitrogen compounds, ammonium hydroxides, and ammonium salts, including, chlorides, bromides, nitrates and sulfates.

8. The flow through absorber (FTA) for TDS ablation as claimed in claim 1, wherein the dual-functional adsorbent can be configured in the form of mesh, mat, membrane or packed bed in the housing of the FTA unit.

9. The flow through absorber (FTA) for TDS ablation as claimed in claim 1, wherein the rinsing liquid can be selected from a group of materials containing tap water, de-ionized water, surface water and seawater of low TDS.

10. The flow through absorber (FTA) for TDS ablation as claimed in claim 1, wherein the electronic controller for TDS ablation has online monitors for detecting the conductivity, pH and TDS of liquids.

11. The flow through absorber (FTA) for TDS ablation as claimed in claim 1, wherein the electronic controller for FTA regeneration has online monitors for detecting the conductivity, pH and TDS of liquids.

12. The flow through absorber (FTA) for TDS ablation as claimed in claim 1, further comprising at least two FTA units connected in parallel.

13. The flow through absorber (FTA) for TDS ablation as claimed in claim 1, further comprising at least two FTA units connected in series.
